(19) United States
(12) Patent Application Publication
(10) Pub. No.: US 2010/0314888 A1
(43) Pub. Date: Dec. 16, 2010

(54) Integration Of An Air Separation Apparatus And of A Steam Reheating Cycle

(75) Inventors: Marie Cognard, Chevilly Larue (FR); Richard Dubettier-Grenier, La Varenne Saint Hilaire (FR); Jens Juckel, Krefeld (DE); Patrick Le Bot, Vincennes (FR)

Correspondence Address: American Air Liquide, Inc.;Intellectual Property Dept., 2700 Post Oak Boulevard, Suite 1800, Houston, TX, 77056, US

(73) Assignees: L'Air Liquide Societe Anonyme Pour L'EDtude Et L'Exloitation Des Procedes Georges Claude, Paris (FR); Siemens Vai Metals Technologies GmbH & Co., Linz (AT)

(21) Appl. No.: 12/866,489

(22) PCT Filed: Feb. 17, 2009
(86) PCT No.: PCT/FR09/50248

§ 371 Date: Aug. 6, 2010

(30) Foreign Application Priority Data
Feb. 18, 2008 (FR) 0851004
Apr. 7, 2008 (FR) 0852296

(51) Int. Cl. H02K 7/18; F01K 7/32

(52) U.S. Cl. 290/1 R; 60/647

(57) ABSTRACT

A process for the integration of an air separation apparatus and of a steam reheat cycle is presented.

The present invention relates to the integration of an air separation apparatus and of a steam reheat cycle.

The use, in an electric power plant, of a steam cycle comprising a steam reheat step in order to improve the energy efficiency of the installation, called the Rankine cycle with reheat, is known.

All the pressures mentioned are absolute pressures.

A booster of an air separation apparatus is a compressor that compresses air already compressed to a pressure of at least 5 bar.

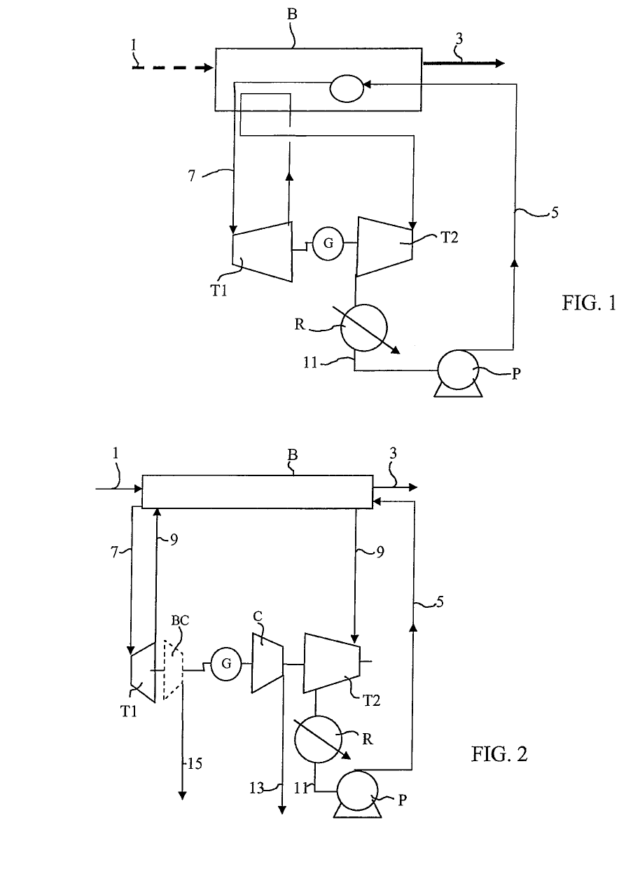

As shown in FIG. 1, steam 7 enters the high pressure turbine T1 at 130 bar and 540° C. and is then expanded to 30 bar and about 300° C., forming the stream 9. The stream 9 then returns to a boiler B where it is reheated to about 540° C. and then sent to the low pressure turbine T2 where it is expanded to the pressure of the condenser R, typically 150 mbar, the condensates 11 are then pumped by the pump P and sent as the stream 5 to the boiler B where they are subcooled to their boiling point, and then vaporized, and finally superheated to 540° C. by heat exchange with an offgas stream 1 from a gas turbine and optionally a post-combustion. The flue gases 3 are discharged from the boiler.

For thermal stress considerations, the high pressure turbine T1 and the low pressure turbine T2 cannot be combined in a single body.

Typically:
the alternator G equipped with a double ended shaft is driven by the two turbines;
the high pressure turbine T1 rotates at a higher speed than the low pressure turbine T2.

A steam cycle with reheat is a cycle in which steam at a high pressure HP (typically above 50 bar) and superheated (typically to a temperature of about 400 to 500° C.) is expanded in a first turbine to a first pressure IP (typically lower than 50 bar), is then heated at this pressure to a temperature approaching the temperature of the HP steam before expansion (the temperature difference between these two steams is typically lower than 100° C.), and finally expanded in a second turbine to a pressure lower than the atmospheric pressure (typically equivalent to 0.2 bar abs.).

According to one object of the invention, a steam cycle work generating method is provided in which:

a) the steam is expanded in a first turbine from a high pressure, generally above 50 bar, and a high temperature, to an intermediate pressure;

b) the steam at intermediate pressure is reheated without substantially changing its pressure;

c) steam reheated at the intermediate pressure is expanded in a second turbine to a low pressure, typically subatmospheric, and a low temperature;

d) at least part of the stream expanded in the second turbine is condensed to form a condensed stream;

e) at least part of the condensed stream is pressurized, optionally in two steps, to form a pressurized stream;

f) at least part of the pressurized stream is reheated to form a reheated stream;

g) at least part of the reheated stream is sent to the first turbine, and

h) a fluid intended for or coming from an air separation apparatus is compressed in at least one compressor coupled to at least one of the first and second turbines.

Optionally:
at least part of the work generated by at least one of the first and second turbines is used to generate electricity;
the first turbine drives a main compressor of an air separation apparatus and/or an air booster of an air separation apparatus and/or a compressor for product from an air separation apparatus;
the second turbine drives a main compressor of an air separation apparatus and/or an air booster of an air separation apparatus and/or a compressor for product from an air separation apparatus;
the first and/or the second turbine drive(s) a generator;
the first turbine and the second turbine are on the same line shafting and drive an air compressor of an air separation apparatus or a compressor for product from a separation apparatus and optionally also a generator;
one or more auxiliary turbines are installed in parallel with the first turbine or to the second turbine, the auxiliary turbine(s) possibly driving a generator and/or a combustible gas compressor and/or a compressor of gas produced by the air separation unit;
step b) and/or f) take(s) place at least partially in at least one boiler;
at least one boiler is fed with an offgas from a gas turbine, the gas turbine being optionally fed with a gas coming from the air separation apparatus and optionally fed with a gas coming from a steelmaking process;
the steelmaking process is a smelting reduction process such as a COREX® process, a FINEX® process or a process derived from one of these two processes;
at least one boiler is heated by combustion of a fuel, optionally coming from a steelmaking process, in the presence of an oxygen-containing gas;
the first and second turbines are not on the same line shafting;
at least one of the first and second turbines drives a first compressor which compresses a fluid intended for or coming from a first air separation apparatus and a second compressor which compresses a fluid intended for or coming from a second air separation apparatus;
at least one of the first and second turbines is on the same shaft as a third turbine that is part of an independent steam cycle;
the independent steam cycle is a Rankine cycle with reheat;
the steam is reheated at intermediate pressure without substantially changing its pressure in a first boiler, part of the steam intended for the first turbine originates from a second boiler and steam expanded to a low pressure in the first turbine is sent to the second boiler after cooling and pumping.

According to another object, the invention comprises a steam cycle comprising a first and a second turbine, means for sending a high pressure steam stream to the first turbine, means for reheating the stream expanded in the first turbine, these means optionally comprising a boiler, means for sending the reheated steam to the second turbine to expand it to a low pressure, typically subatmospheric, and a low temperature, means for and means for compressing a fluid intended for or coming from an air separation apparatus in at least one compressor coupled to at least one of the first and second turbines.

Optionally, the cycle may comprise:
an electric power generator coupled to at least one of the first and second turbines;
the first turbine drives a main compressor of an air separation apparatus and/or an air booster of an air separation apparatus and/or a compressor for product from an air separation apparatus;
the second turbine drives a main compressor of an air separation apparatus and/or an air booster of an air separation apparatus and/or a compressor for product from an air separation apparatus;
the first turbine and the second turbine are on the same line shafting and drive an air compressor of an air separation apparatus or a compressor for product from a separation apparatus and optionally also a generator;
the means for reheating the stream expanded in the first turbine comprise at least one boiler;
at least one boiler is fed with an offgas from a gas turbine, the gas turbine optionally being fed with a gas coming from the air separation apparatus;
at least one boiler is heated by combustion of a fuel in the presence of an oxygen-containing gas;
the first and second turbines are not on the same line shafting;
at least one of the first and second turbines drives a first compressor which compresses a fluid intended for or coming from a first air separation apparatus and a second compressor which compresses a fluid intended for or coming from a second air separation apparatus;
at least one of the first and second turbines is on the same shaft as at least one third turbine that is part of an independent steam cycle;
the independent steam cycle is a Rankine cycle with reheat;
the cycle comprises a first boiler for reheating the steam at intermediate pressure without substantially changing its pressure, a second boiler, means for sending steam from the second boiler to the first turbine, means for cooling steam expanded to a low pressure in the first turbine, means for pumping the condensed steam and means for sending the condensed steam to the second boiler.

According to the invention, a steam cycle with reheat is used as described above to mechanically drive at least one compressor of an air separation apparatus.

The invention will be described in greater detail with reference to FIGS. 2 to 9 which show integrated cycles according to the invention.

FIG. 2 shows the Rankine cycle with reheat in which steam is expanded from a pressure of at least 50 bar, for example at 130 bar, and at a high temperature, for example 540° C., and is then expanded to an intermediate pressure, for example 30 bar, and an intermediate temperature, for example about 300° C., forming the stream 9. The stream 9 then returns to a boiler B where it is reheated to a temperature approaching that of the stream 7, for example about 540° C., before being sent to the low pressure turbine T2 where it is expanded to the pressure of the condenser R, this pressure being subatmospheric, typically 150 mbar. The condensates 11 are then pumped by the pump P and returned as the stream 5 to the boiler B where they are subcooled to their boiling point, and then vaporized, and finally superheated to 540° C. by heat exchange with an offgas stream 1 from a gas turbine and optionally a post-combustion or from the burner of a conventional boiler. The flue gases 3 are discharged from the boiler.

The two turbines T1, T2 are fixed to a double ended shaft which drives the generator G and the compressor 13 of an air separation apparatus C producing an air stream 13 at a pressure between 5 and 12 bar. Alternatively or additionally, an air booster BC of an air separation apparatus may be driven by the two turbines T1, T2 and produces an air stream 15 at between 12 and 40 bar.

In the figures below, the streams 1, 3 of FIGS. 1 and 2 do not appear but are nevertheless present.

In a practical embodiment, the condensates can be compressed in two steps: a first step in which the condensates are pumped to a pressure of about 5 bar, and then partially subcooled, and then deaerated (removal of dissolved air) by steam injection, and finally repumped to the entry pressure of the high pressure turbine (about 130 bar).

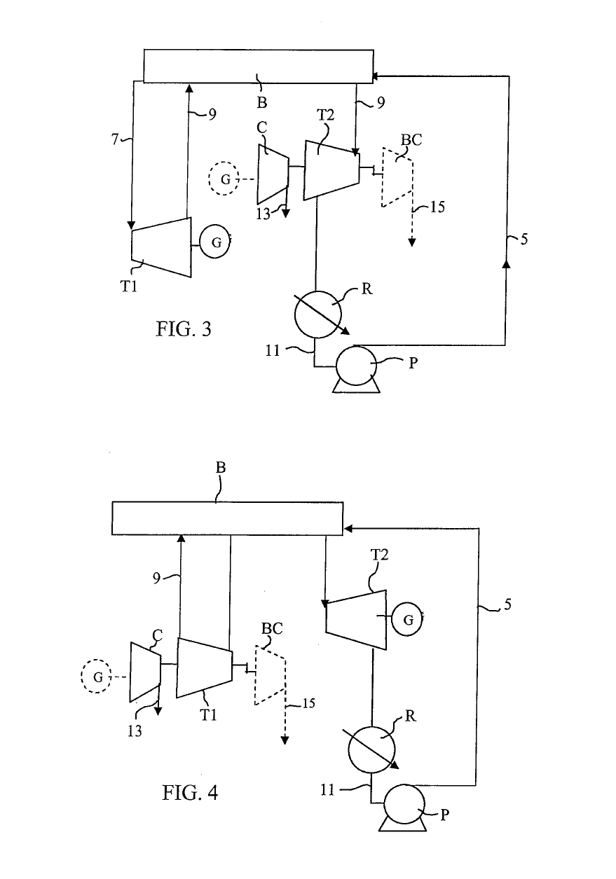

FIG. 3 shows the Rankine cycle with reheat in which steam is expanded from a pressure of at least 50 bar, for example at 130 bar, and at a high temperature, for example 540° C., and is then expanded to an intermediate pressure, for example 30 bar, and an intermediate temperature, for example about 300° C., forming the stream 9. The stream 9 then returns to a boiler B where it is reheated to a temperature approaching that of the stream 7, for example about 540° C., before being sent to the low pressure turbine T2 where it is expanded to the pressure of the condenser R, this pressure being subatmospheric, typically 150 mbar. The condensates 11 are then pumped by the pump P and returned as the stream 5 to the boiler B where they are subcooled to their boiling point, and then vaporized, and finally superheated to 540° C. by heat exchange with an offgas stream from a gas turbine and optionally a post-combustion or from the burner of a conventional boiler. The flue gases are discharged from the boiler.

The first turbine T1 is coupled to a generator G and the second turbine T2 is fixed to a shaft which drives the compressor 13 of an air separation apparatus C producing an air stream 13 at a pressure between 5 and 12 bar. Alternatively or additionally, an air booster BC of an air separation apparatus may be driven by the second turbine T2 and produces an air stream 15 at between 12 and 40 bar. Alternatively or additionally, a generator G is driven by the turbine T2. With this arrangement, the machines can be serviced independently. Additionally, one (or more) auxiliary turbine(s) T3 may be installed in parallel with the turbine T2 and expand the excess steam not consumed by the turbine T2. This turbine T3 may drive a generator and/or a compressor of combustible gas (which is fed to a gas turbine).

FIG. 4 shows the Rankine cycle with reheat in which steam is expanded from a pressure of at least 50 bar, for example at 130 bar, and at a high temperature, for example 540° C., and is then expanded to an intermediate pressure, for example 30 bar, and an intermediate temperature, for example about 300° C., forming the stream 9. The stream 9 then returns to a boiler B where it is reheated to a temperature approaching that of the stream 7, for example about 540° C., before being sent to the low pressure turbine T2 where it is expanded to the pressure of the condenser R, this pressure being subatmospheric, typically 150 mbar. The condensates 11 are then pumped by the pump P and returned as the stream 5 to the boiler B where they are subcooled to their boiling point, and then vaporized, and finally superheated to 540° C. by heat exchange with an offgas stream from a gas turbine and optionally a post-combustion or from the burner of a conventional boiler. The flue gases are discharged from the boiler.

The first turbine T1 is coupled to the compressor 13 of an air separation apparatus C producing an air stream 13 at a pressure between 5 and 12 bar and optionally to a generator G. Alternatively or additionally, an air booster BC of an air separation apparatus may be driven by the first turbine T1 and produces an air stream 15 at between 12 and 40 bar. The second turbine T2 drives a generator G.

Additionally, one (or more) auxiliary turbine(s) T3 may be installed in parallel with the turbine T1 and expand the excess steam not consumed by the turbine T1. This turbine T1 may drive a generator and/or a compressor of combustible gas (which is fed to a gas turbine).

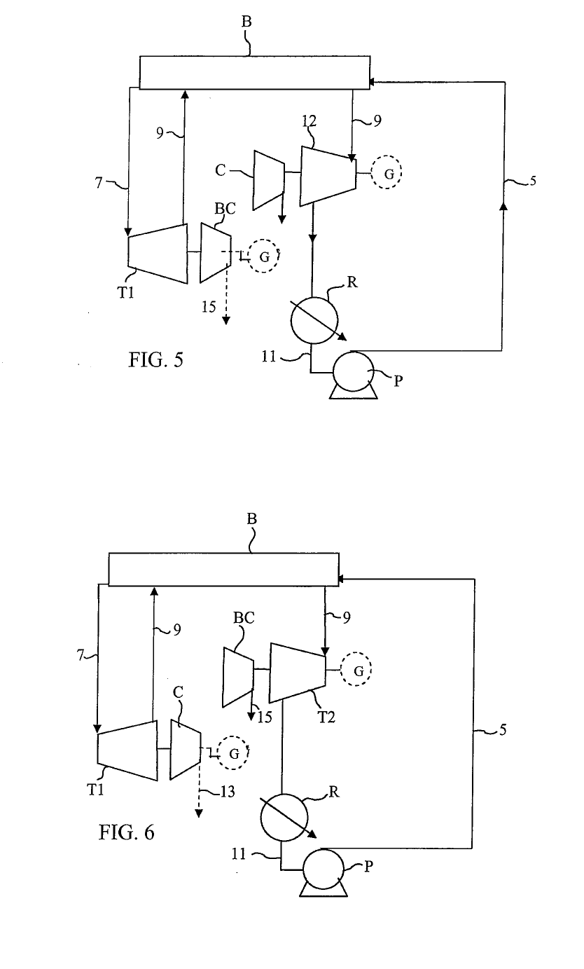

FIG. 5 shows the Rankine cycle with reheat in which steam is expanded from a pressure of at least 50 bar, for example at 130 bar, and at a high temperature, for example 540° C., and is then expanded to an intermediate pressure, for example 30 bar, and an intermediate temperature, for example about 300° C., forming the stream 9. The stream 9 then returns to a boiler B where it is reheated to a temperature approaching that of the stream 7, for example about 540° C., before being sent to the low pressure turbine T2 where it is expanded to the pressure of the condenser R, this pressure being subatmospheric, typically 150 mbar. The condensates 11 are then pumped by the pump P and returned as the stream 5 to the boiler B where they are subcooled to their boiling point, and then vaporized, and finally superheated to 540° C. by heat exchange with an offgas stream from a gas turbine and optionally a post-combustion or from the burner of a conventional boiler. The flue gases are discharged from the boiler.

The first turbine T1 is coupled to the air booster BC of an air separation apparatus and produces an air stream 15 at between 12 and 40 bar. It is optionally also coupled to a generator G. The second turbine T2 drives the compressor 13 of an air separation apparatus C producing an air stream 13 at a pressure between 5 and 12 bar and optionally a generator G.

Additionally, one (or more) auxiliary turbine(s) T3 may be installed in parallel with the turbine T1 and expand the excess steam not consumed by the turbine T1. This turbine T1 may drive a generator and/or a compressor of combustible gas (which is fed to a gas turbine).

Additionally, one (or more) auxiliary turbine(s) T4 may be installed in parallel with the turbine T2 and expand the excess steam not consumed by the turbine T2. This turbine T4 may drive a generator and/or a compressor of combustible gas (which is fed to a gas turbine).

FIG. 6 shows the Rankine cycle with reheat in which steam is expanded from a pressure of at least 50 bar, for example at 130 bar, and at a high temperature, for example 540° C., and is then expanded to an intermediate pressure, for example 30 bar, and an intermediate temperature, for example about 300° C., forming the stream 9. The stream 9 then returns to a boiler B where it is reheated to a temperature approaching that of the stream 7, for example about 540° C., before being sent to the low pressure turbine T2 where it is expanded to the pressure of the condenser R, this pressure being subatmospheric, typically 150 mbar. The condensates 11 are then pumped by the pump P and returned as the stream 5 to the boiler B where they are subcooled to their boiling point, and then vaporized, and finally superheated to 540° C. by heat exchange with an offgas stream from a gas turbine and optionally a post-combustion or from the burner of a conventional boiler. The flue gases are discharged from the boiler.

The first turbine T1 is coupled to the compressor 13 of an air separation apparatus C producing an air stream 13 at a pressure between 5 and 12 bar and optionally to a generator G. The air booster BC of an air separation apparatus is driven by the second turbine T2 and produces an air stream 15 at between 12 and 40 bar. The second turbine T2 optionally drives a generator G.

Additionally, one (or more) auxiliary turbine(s) T3 may be installed in parallel with the turbine T1 and expand the excess steam not consumed by the turbine T1. This turbine T1 may drive a generator and/or a compressor of combustible gas (which is fed to a gas turbine).

Additionally, one (or more) auxiliary turbine(s) T4 may be installed in parallel with the turbine T2 and expand the excess steam not consumed by the turbine T2. This turbine T4 may drive a generator and/or a compressor of combustible gas (which is fed to a gas turbine).

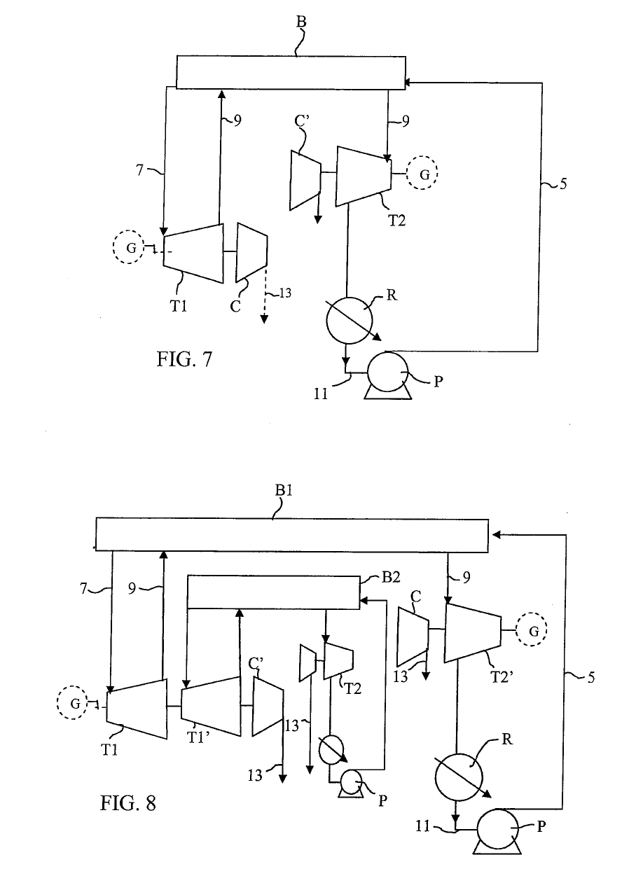

FIG. 7 shows the Rankine cycle with reheat in which steam is expanded from a pressure of at least 50 bar, for example at 130 bar, and at a high temperature, for example 540° C., and is then expanded to an intermediate pressure, for example 30 bar, and an intermediate temperature, for example about 300° C., forming the stream 9. The stream 9 then returns to a boiler B where it is reheated to a temperature approaching that of the stream 7, for example about 540° C., before being sent to the low pressure turbine T2 where it is expanded to the pressure of the condenser R, this pressure being subatmospheric, typically 150 mbar. The condensates 11 are then pumped by the pump P and returned as the stream 5 to the boiler B where they are subcooled to their boiling point, and then vaporized, and finally superheated to 540° C. by heat exchange with an offgas stream from a gas turbine and optionally a post-combustion or from the burner of a conventional boiler. The flue gases are discharged from the boiler.

The first turbine T1 is coupled to the compressor of a first air separation apparatus C producing an air stream 13 at a pressure between 5 and 12 bar and optionally to a generator G.

The second turbine T1 is coupled to the compressor C′ of a second air separation apparatus, producing an air stream 13′ at a pressure between 5 and 12 bar, and optionally to a generator G.

FIG. 8 shows a cycle in which two boilers B, B′ are integrated.

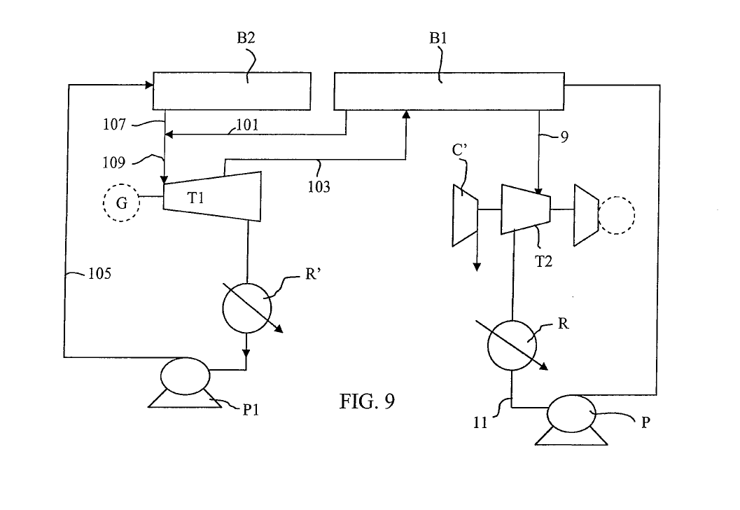

FIG. 9 shows a cycle in which two boilers B1, B2 are used. In this case, high pressure steam 101 from a first boiler B1 is mixed with high pressure steam 107 from a second boiler B2 to form a stream 109. This common stream 109 is expanded in a turbine T1. A steam stream 103 is tapped intermediately from the turbine T1 and a stream 105 expanded in the whole turbine T1 is cooled, pumped and recycled to the second boiler B2. The stream 103 is sent to the first boiler B1 where it is reheated. The reheated stream 9 is expanded in a turbine T2 which drives at least one compressor C′ of an air separation apparatus. The expanded steam is recycled to the first boiler after cooling R′ and pumping P′.

1-15. (canceled)

16. A method for generating steam cycle work, comprising:
a) expanding steam in a first turbine from a high pressure, and a high temperature, to an intermediate pressure;
b) reheating the intermediate pressure steam without substantially changing its pressure;
c) expanding the reheated steam in a second turbine to a low pressure, and a low temperature;
d) condensing at least part of the stream expanded in the second turbine to form a condensed stream;
e) pressurizing at least part of the condensed stream to form a pressurized stream;
f) reheating at least part of the pressurized stream to form a reheated stream;
g) sending at least part of the reheated stream to the first turbine, and
h) compressing a fluid intended for or coming from an air separation apparatus in at least one compressor that is coupled to at least one of the first and second turbines.

17. The method of claim 16, wherein said high pressure is above 50 bar.

18. The method of claim 16, wherein said low pressure is subatmospheric.

19. The method of claim 16, wherein said condensed stream pressurization is performed in two steps.

20. The method of claim 16, wherein at least part of the work generated by at least one of the first and second turbines is used to generate electricity.

21. The method of claim 16, wherein at least one of the first turbine and the second turbine drives one or more devices selected from the group consisting of a main compressor of an air separation apparatus, an air booster of an air separation apparatus, a compressor for product from an air separation apparatus, and a generator.

22. The method of claim 16, wherein, the first turbine and the second turbine are on the same line shafting and drive an air compressor of an air separation apparatus or a compressor for product from a separation.

23. The method of claim 22, wherein the first turbine and the second turbine also drive a generator.

24. The method of claim 16, wherein one or more auxiliary turbines are installed in parallel with the first turbine or to the second turbine.

25. The method of claim 24, wherein the auxiliary turbine possibly drives one or more devices selected from the group consisting of a generator, a combustible gas compressor, and a compressor of gas produced by the air separation unit

26. The method of claim 16, wherein step b) and/or f) take(s) place at least partially in at least one boiler.

27. The method of claim 26, wherein at least one boiler is fed with an offgas from a gas turbine.

28. The method of claim 27, wherein the gas turbine is fed with a gas coming from the air separation apparatus.

29. The method of claim 27, wherein the gas turbine is fed with a gas coming from a steelmaking process.

30. The method of claim 26, wherein at least one boiler is heated by combustion of a fuel in the presence of an oxygen-containing gas.

31. The method of claim 30, wherein the fuel comes from a steelmaking process.

32. The method of claim 16, wherein the first and second turbines are not on the same line shafting.

33. The method of claim 16, wherein at least one of the first and second turbines drives a first compressor which compresses a fluid intended for or coming from a first air separation apparatus and a second compressor which compresses a fluid intended for or coming from a second air separation apparatus.

34. The method of claim 16, wherein at least one of the first and second turbines is on the same shaft as a third turbine that is part of an independent steam cycle.

35. The method of claim 34, wherein the independent steam cycle is a Rankine cycle with reheat.

36. The method of claim 16, wherein the steam is reheated at intermediate pressure without substantially changing its pressure in a first boiler, part of the steam intended for the first turbine originates from a second boiler and steam expanded to a low pressure in the first turbine is sent to the second boiler after cooling and pumping.
